(19) United States
(12) Patent Application Publication
(10) Pub. No.: US 2006/0183635 A1
(43) Pub. Date: Aug. 17, 2006

(54) Atmosphere heat treatment cocatalyst, method of its application, heat treatment method and heat treatment atmosphere of using the cocatalyst

(76) Inventor: Langen Li, Shaanxi (CN)

Correspondence Address: ROBERT M. HUNTER PLLC, P.O. BOX 2709, KAMUELA, HI, 96743, US

(21) Appl. No.: 10/520,563

(22) PCT Filed: Jul. 9, 2002
(86) PCT No.: PCT/CN02/00486

§ 371 Date: Jan. 7, 2005

(30) Foreign Application Priority Data
Jul. 9, 2001 (CN) 01128712.8

(51) Int. Cl. B01J 31/00; B01J 27/06; B01J 27/24

(52) U.S. Cl. 502/224; 502/200; 502/152; 502/150; 502/167; 502/155

(57) ABSTRACT

The present invention provides operational methods for using cocatalysts in atmosphere heat treatment. The cocatalyst are dissolved or dispersed into an atmosphere material or atmosphere directly or indirectly, and the cocatalyst are maintained in the form of a gas phase or a very fine dispersion (such as a dust) and diffuse into the atmosphere in the heat treatment equipment or heat treatment gas-producing equipment so that the cocatalyst has the largest area in contact with the atmosphere material and atmosphere and plays a part in catalysis and activation of the atmosphere in atmosphere heat treatment. Also the present invention provides a variety kind of cocatalysts for atmosphere heat treatment of metal material and methods of atmosphere heat treatment.

### TECHNOLOGY AREA

The present invention involves a kind of atmosphere heat treatment cocatalyst and its application. In heat treatment equipment or heat treatment gas-producing equipment, the cocatalyst is dispersed into the atmosphere material or atmosphere in the form of a gas phase or a very fine dispersion (such as motes), or it can release a substance with a function of the cocatalyst. The present invention also involves various heat treatment methods using said cocatalyst and said method.

### TECHNOLOGY BACKGROUND

Heat treatment atmosphere, generally refers to a heat treatment protection atmosphere and a chemical heat treatment atmosphere, consists of H₂, N₂, CO, a small amount of CH₄, CO₂, H₂O, NH₄ as well as unsaturated hydrocarbons.

Almost all carbon compounds can decompose or react with water and air at high temperature to create a heat treatment atmosphere. Carbon compounds that can be heat treatment atmosphere materials such as Methanol, Ethanol, N-butyl Alcohol, Lopropylalcohol, Acetone, Ethyl acetate, Aniline, Toluene, Xylenes, Kerosene, charcoal, Activated carbon, Dimethylmethanemethane, Butane, Natural gas, Coal gas, etc.

When carbon compounds are used as heat treatment atmosphere material, their functions are accordant. In other words, certain carbon are provided and decomposed at high temperature or react with water and air to create a heat treatment atmosphere with H₂, N₂, CO and a small amount of CH4, CO₂, H₂O, NH4. Therefore, one kind of material can be replaced by another in practice.

In existing technology, many aerate an atmosphere material containing H₂O, and air and Methanol into the heat treatment equipment, making use of the heat treatment process to create a heat treatment atmosphere. Many international and Chinese heat treatment enterprises and heat treatment equipment manufacturers have adopted this method.

Said method has the advantage of lower investment in equipment initially but as a result of limitations of the workpiece and the heat treatment equipment, higher processing temperatures may not be selected. A kind of proper method for using a catalyst at the equipment conditions has not been discovered to date. So said exists widely insufficient of atmosphere material decomposition and more carbon soot is produced because of use of lower temperatures and a lack of a cocatalyst, production and processing control are much limited and negatively affected.

To solve said problem, many international and Chinese heat treatment enterprises and heat treatment equipment manufacturers have adopted the method of increasing a sort of special gas-producing facility outside of the heat treatment equipment. The special gas-producing facility is filled with a lot of various shaped cocatalysts (accelerants) having many holes. The principle of the holes is material has greater contact with the gas so that the atmosphere material contact with the surface of cocatalyst and be catalyzed during production.

Because the gas-producing facility can be operated at a higher processing temperature and catalysis is used as well, the problem of carbon soot can be solved to certain degree.

At present, some have attempted coating the cocatalyst directly on the inside walls of the heat treatment equipment that contact with the atmosphere material, or providing fixtures and inside walls of the furnace made of the material having a catalytic effect and so on expecting to increase atmosphere decomposition and decrease carbon soot, however, the result is not any better than using gas-producing equipment.

No matter what kind of equipment is used or what form of atmosphere is employed, reducing carbon soot has always been the dream of heat treatment experts. Reducing carbon soot brings a great deal of advantage to production and the processing control. Especially in chemical heat treatment carburizing and carbonitriding, there is a desire to accelerate carburizing speed and production efficiency or lower processing temperature to improve the quality of heat treatment production in high carbon potential control, but because of the effect of carbon soot, the expectation cannot be realized (it is easy to create carbon soot at a high carbon potential).

It is inescapable that carbon soot will be created even with the use of a gas-producing facility with existing technology. Once carbon soot is formed, it attaches on the surface of cocatalysts, obstructs the contact between the atmosphere material and cocatalyst, and affects catalysis and makes cocatalysis harder to realize.

In addition, the cocatalyst (accelerant) has the property of poisoning and aging inescapably during the process; despite we may take a step to inspirit the catalyst over time.

Whether catalyst aging, poisoning or carbon soot attachment on the surface of catalyst will affect the activation of the catalyst, make carbon soot increase, further decrease catalysis activity or lose the chance of contacting with atmosphere material as the effect of carbon soot, activation and the production is decreased. Therefore, it is necessary to find a kind of cocatalyst without the effect of aging, poisoning and carbon soot in a heat treatment atmosphere.

### INVENTION CONTENT

The purpose of the present invention is to invent a kind of cocatalyst compound without the effect of aging, poisoning and carbon soot for heat treatment atmospheres and an operational method of the cocatalyst so that the cocatalyst plays a part of in catalysis and activation in a heat treatment atmosphere formed by an atmosphere material, reduces carbon soot and achieves protective atmosphere heating and chemical heat treatment. Carburizing and carbonitriding can be practiced at a higher carbon potential with less carbon soot as well as enhanced efficiency, quality and stability of the heat treatment process, at decreased process cost.

A operational method of practicing the present invention is that a cocatalyst is dissolved or dispersed into a heat treatment atmosphere material and heat treatment atmosphere, and the cocatalyst is maintained in the form of a gas phase or a finer dispersion (such as a dispersion of dust) and diffused into the atmosphere material and/or atmosphere in the heat treatment equipment or heat treatment gas-producing equipment. In practicing of the present invention, a cocatalyst is dissolved or dispersed directly or indirectly into a heat treatment atmosphere material and a heat treatment atmosphere, and the cocatalyst is maintained in the form of a gas phase or a finer dispersion (such as a dispersion of dust or small particles) and is diffused into the atmosphere material and/or the atmosphere in the heat treatment equipment or heat treatment gas-producing equipment so that the cocatalyst has contact of with the largest area with the atmosphere material the atmosphere, thereby adequately exerting cocatalysis and activation of the cocatalyst.

The cocatalysts of the present invention mean to be such compounds that have catalysis of a heat treatment atmosphere and activation of a heat treatment atmosphere or release a kind of substance having the same function of said substance in the process conditions of heat treatment.

In the present invention, the term ‘finer dispersion’ means particles or fluid drops that can be suspended in a heat treatment atmosphere for enough time, wherein experts in this field ‘enough time’ is the time of playing an obvious part in catalysis of said reaction, or an equivalent time.

An implementary practice in the present invention provides a kind of heat treatment atmosphere cocatalyst. When the cocatalyst is in the heat treatment equipment or heat treatment gas-producing equipment, it is in the form of a gas phase or a finer dispersion and diffuses in the atmosphere material or atmosphere. In a concrete practice of this invention, the cocatalyst exists in the form of a gas phase or a finer dispersion, diffuses directly into the heat treatment atmosphere material or heat treatment atmosphere or the cocatalyst is dissolved or dispersed into a kind or kinds of material that acts as a carrying agent and is fed into the heat treatment equipment or heat treatment gas-producing equipment together with the carrying agent material.

It is worthwhile to say that the present invention is not concrete limitation to atmosphere material, and the atmosphere material can be one or more than one atmosphere material. As long as the cocatalysts can diffuse in the atmosphere material or atmosphere in the form of a gas phase or a finer dispersion in the heat treatment equipment or heat treatment gas-producing equipment in a heat treatment process, the atmosphere material can be used.

The heat treatment atmosphere materials mentioned in present invention are meant to be all known atmosphere materials, for example, Methanol, Ethanol, N-butyl Alcohol, Lsopropylalcohol, Xylenes, Toluene, Aniline, Acetone, Ethyl, Acetate, Kerosene, Methane, Ethane, Dimethylmethanemethane, Butane, RX gas, Natural gas, Coal gas, Nitrogen, or they is added water or air.

In the implementary practice of the invention, said cocatalyst is directly dissolved, dispersed into the heat treatment atmosphere material or heat treatment atmosphere and is aerated into the heat treatment equipment or heat treatment gas-producing equipment.

In the practice of the present invention, the cocatalyst is dissolved or dispersed into a kind of material as heat treatment atmosphere material in advance to make a compound (‘carrying agent’ in the text) such as cocatalyst solution. In practice, the compound such as the cocatalyst solution is added into the heat treatment atmosphere material or cocatalyst solution is input to the heat treatment equipment or heat treatment gas-producing equipment together with the heat treatment atmosphere material.

In implementary practice in the present invention, the cocatalyst is selected from one or an arbitrary combination of a metal element compound which takes 0.0003-0.03% weight in the heat treatment atmosphere material, optimal selection: 0.0003-0.015%, a nitrogen compound which takes 1-10% weight in the heat treatment atmosphere material, optimal selection: 0.1-2%; and a halogen element compound which takes 0.1-4% weight in the heat treatment atmosphere material, optimal selection: 0.1-1%.

Said metal element compound is selected from one of Cobalt naphthenate, Manganese naphthenate, Nickel nitrate, Manganese nitrate, Ferrocene, Ferrocene ramification, or an arbitrary combination thereof. Optimal selection is: Ferrocene and/or Ferrocene ramification.

Said halogen element compound is selected from one of Chlorobenzene, Trichlorobenzene, Chlorotoluene, Nitrochlorobenzene, Trichloroethylene, Tribromomethane, Iodine, Iodinated Oil, Iodomethane, Freone, Tetrafluoroethylene, or a arbitrary combination thereof. Optimal selection is: Chlorobenzene, Trichlorobenzene, Chlorotoluene, Nitrochlorobenzene or their combination.

Said nitrogen compound is selected from one of P-Amino-Azobenzene Hydrochloride, Nitrobenzene, Toluene diisocyanate, Nitrochlorobenzene, Nitrobenzene, Trinitrobenzene, Melamine, Tricyanic acid, Dicyandiamide, Guanidine nitrate, Cyclotrimethylenetrinitramine, Pyridine, Pyrazole, Pyraze, or their arbitrary combination. Optimum selection is: one of P-Amino-Azobenzene Hydrochloride, Nitrobenzene, Toluene, Toluene diisocyanate, Nitrochlorobenzene, Nitrobenzene, Trinitrobenzene, Guanidine nitrate, Cyclotrimethylenetrinitramine, or their arbitrary combination.

In a implementary practice of the invention, the compound of the rare earth lanthanum or the rare earth cerium which takes 0.03-3% weight in the heat treatment atmosphere material can be added to the heat treatment atmosphere material or heat treatment atmosphere. For example, the compound is one of Cerium naphthenates, Lanthanum naphthenates Cerium nitrate, Lanthanum nitrate, Lanthanum chloride, Cerium chloride, lanthanum fluoride, cerium fluoride, Lanthanum Acetate, Cerium Acetate, or their arbitrary combination. Optimal selection is: Lanthanum Acetate, Cerium Acetate, Lanthanum oxide, Cerium oxide or their arbitrary combination, because they are not eroded in the atmosphere.

With respect to said metal element compound, halogen compound, nitrogen compound and the rare earth lanthanum or the rare earth cerium compound, although various concrete examples are stated above, the present invention is not limited to said instances and suits for various chemicals with as the similar as said Compounds.

In another implementary practice of the atmosphere heat treatment method, one or more than one of said four kinds of cocatalysts respectively are adopted with different dosages.

Another purpose in the present invention is to provide an atmosphere heat treatment method for metal material. The method is practiced with the cocatalyst or the active atmosphere of its released substance. The cocatalyst diffuses in the atmosphere in the form of a gas or finer dispersion.

In an implementary practice of the atmosphere heat treatment invention, the cocatalyst is diffused directly into the heat treatment atmosphere material or heat treatment atmosphere, or the cocatalyst is dissolved or dispersed into the heat treatment atmosphere material in advance to make an admixture, such as a cocatalyst solution. In usage, the admixture such as a cocatalyst solution is added into the heat treatment atmosphere material, or is aerated into the heat treatment equipment or heat treatment gas-producing equipment together with the heat treatment atmosphere material. In an atmosphere heat treatment practice of the present invention, said cocatalyst is used.

In an implementary practice of the invention, carburizing and carbonitriding take place in a higher carbon potential, optimal selection: 0.25, better optimal selection: 0.15 carbon potential, or lower obviously temperature, or shorter obviously time in when using said cocatalyst than without said cocatalyst.

An implementary practice of the present invention is a heat treating method for a protection atmosphere. The heat treatment processing is practiced with the cocatalyst or the active atmosphere released by the cocatalyst, the cocatalysts diffuse into the said atmosphere in a gas phase or finer dispersion.

Another purpose of the present invention is to provide a kind of heat treatment atmosphere for metal material. The atmosphere comprises a cocatalyst and its release substance that both are diffused into the atmosphere material or atmosphere in a gas phase or finer dispersion such as mote (suspending for long time) in the heat treatment equipment or heat treatment gas-producing equipment. The cocatalyst and its release substance play a catalysis to atmosphere material and activation to the atmosphere in the heat treatment process.

The invention also provides a kind of method of raising heat treatment atmosphere carbon potential and falling carbon soot, the characteristic consists in adding a kind of or kinds of the cocatalysts into the heat treatment atmosphere or atmosphere material.

The invention also provides a kind of carburizing, carbonitriding or nitrocarburizing method in heat treatment. The characteristic consists in putting a kind of or kinds of said cocatalysts in a heat treatment atmosphere or atmosphere material. Proper ammonia gas is may aerated in carbonitriding or nitrocarburizing.

In the present invention, a new cocatalyst comes into continuously the a catalyst surroundings and a heat treatment atmosphere together with atmosphere material and participates in the reaction, thereby avoiding the problems of cocatalyst aging, poisoning and the problem caused by carbon soot. etc

In the method stated in this invention, said cocatalyst is aerated to the equipment and is blended fully with the atmosphere material or atmosphere throughout atmosphere cycle system, accordingly achieving the catalysis of the largest area.

The direct method includes (but does not limits) dispersing cocatalyst into a heat treatment atmosphere material and/or atmosphere by various direct means. For example:

1. The cocatalyst is gasified or atomized by a simple gasifying or atomizing system, then is aerated into the heat treatment equipment and heat treatment gas-producing equipment together with atmosphere material, and takes place in the reaction.

2. Put the cocatalyst and atmosphere material into the heat treatment equipment or heat treatment gas-producing equipment together, making the cocatalyst and the atmosphere material gasify and take part in the reaction in the high temperature of the equipment.

The the indirect method includes (but does not limits) diffusing the cocatalyst into the heat treatment atmosphere material and/or atmosphere by every indirect means. For example:

1. The cocatalyst is dissolved, dispersed into the atmosphere material or material and are aerated into the equipment together.

2. A kind or kinds of materials are selected as carrying agents which do not have a negative effect to on the heat treatment atmosphere or heat treatment process, such carrying agent being one or more than one of Methanol, Ethanol, Aniline, Toluene, Xylenes, Kerosene, Ethanol, N-butylalcohol, Lsopropylalcohol, Acetone, Ethyl Acetate, Dimethylmethanemethane, Butane, Rx-gas, Coal gas, Nitrogen or any of them with water or air added, the cocatalyst is dissolved or dispersed into the carrying agent, then they are input to equipment together with atmosphere material.

In the method stated in the present invention, the cocatalyst is aerated into the equipment and is blended fully with atmosphere material or atmosphere throughout atmosphere cycle system, accordingly achieving the catalysis of largest contact area.

The cocatalyst used in the present invention includes principally four kinds of cocatalysts as follows:

1. All of material that have a catalysis effect in a heat treatment atmosphere formed by an atmosphere material. For example, one or more than one metal element compounds can selected as the cocatalyst from Cobalt naphthenate, Manganese naphthenate, Nickel nitrate, Manganese nitrate, Ferroceneas well as as Ferrocene ramification (such as Tert-butyl Ferrocene, Acetyl Ferrocene, Ferrocenyl ketone, Ferrocene Formic Acid, Butyl Ferrocene etc. Optimal selection: Ferrocene and Ferroceneramification. The cocatalyst takes 0.0003-0.03% by weight in atmosphere material. Optimal selection: 0.0003-0.015%.

2. A halogen element compound which takes 0.1-4% by weight in atmosphere material, Optimal selection: 0.1-1%. For example, one or more than one of compounds are selected as the cocatalyst from Chlorobenzen, Trichlorobenzene, Toluene, Chlorotoluen, Nitrochlorobenzene, Trichloroethylene, Tribromomethane, Iodine, Iodinated Oil, Iodomethane, Freone, Tetrafluoroethylene. Optimal selection: Chlorobenzene, Trichlorobenzene, Nitrochlorobenzene. The halogen element compound can release ions at high temperature, and the ions combine with the hydrogen in the atmosphere to create halogenated hydrogen which can activize the surface of the workpiece and speed up a chemical heat treatment reaction at the phase interface. In order to control the corrosion of halogenated hydrogen to proper limit, it is better to select a more lower dosage. (There is use of some of said material in existing technologies, but the dosage is big, thereby signal measure of the carbon potential sensor probe, the application is limited).

3. A nitrogen compound which takes 1-10% by weight in the atmosphere material, optimal selection: 0.1-2%. For example, one or more than one of compounds are selected as the cocatalyst from P-Amino-Azobenzene Hydrochloride, Nitrochlorobenzene, Nitrobenzene, Trinitrobenzene, Melamine, Tricyanic acid, Dicyandiamide, Guanidine nitrate, Nitrobenzene, Toluene, Toluene diisocyanate, Cyclotrimethylenetrinitramine, Pyridine, Pyrazole, Pyraze. Optimal selection: P-Amino-Azobenzene Hydrochloride, Nitrobenzene, Toluene, Toluene diisocyanate, Nitrochlorobenzene, Nitrobenzene, Trinitrobenzene, Guanidine nitrate, Cyclotrimethylene trinitramine. In carburizing and carbonitriding in chemical heat treatment, the cocatalyst releases active nitrogen during heat treatment processing to accelerate each others reactions with the carbon in atmosphere.

4. Using three kinds of said cocatalysts, it is better to add a RE(lanthanum) compound or a RE(cerium) compound which takes 0.03-3% by weight in the atmosphere material fed into the heat treatment equipment into atmosphere material or atmosphere. One of the compounds can be selected such as from Cerium naphthenates, Lanthanum Naphthenates, Cerium nitrate, Lanthanum Nitrate, Lanthanum chloride, Cerium chloride, Lanthanum fluoride, Cerium fluoride, Lanthanum acetate, Cerium acetate, Lanthanum oxide, or Cerium oxide. Optimal selection: Lanthanum acetate, Cerium acetate, Lanthanum oxide, and Cerium oxide. To select is for decreasing corrosion

The present invention is suitable for heat treatment atmosphere producing and heat treatment production. Heat treatment atmosphere comprising H₂, N₂, CO as well as a small number of the compounds CH₄, CO₂, H₂O and NH₄ that are made of atmosphere materially any useful material. The four kinds of said cocatalysts in the present invention have equal functions in operation. One or more than one of the combinations can be used in chemical heat treatment. The metal element compound should be selected mostly for protective atmosphere heating or protective atmosphere producing.

Making use of the method stated in the present invention, it can be achieved to raise the gas-producing quantity of a heat treatment atmosphere material, reduce carbon soot, lower processing temperature of chemical heat treatment and speed up carburizing, carbonitriding and nitrocarburizing in chemical heat treatment.

Making use of the present invention can obtain the achievements as following:

1. Atmosphere material can be decomposed fully, carbon soot is decreased and gas-producing quality tends to be stable in heat treatment.

2. The controllable property and the stability of the heat treatment process is strengthened.

3. It can be leaved out to heat treatment atmosphere generator, atmosphere material and energy sources can be saved.

4. The carbon soot is hardly created at higher atmosphere carbon potential in heat treatment.

5. Process temperature in chemical heat treatment can be lowered by about 50 degree C., thereby fining metallography structures, reducing the distortion of workpiece.

6. Carburizing and carbonitriding can be speeded up more than about 40% at the same process temperature with ordinary chemical heat treatment, obviously increasing efficiency of production and saving electricity costs.

### FIG ILLUSTRATES

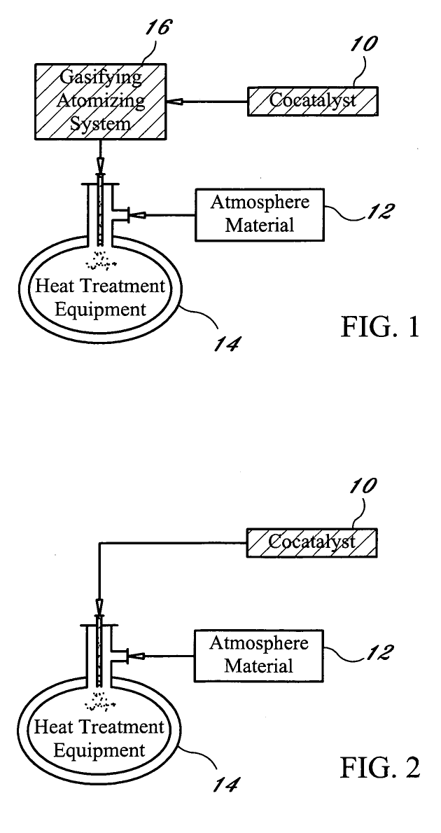

FIG. 1 is a sketch that illustrates the cocatalyst being gasified and atomized by system and entering the heat treatment equipment or heat treatment gas-producing equipment together with atmosphere material.

FIG. 2 is a sketch that illustrates the cocatalyst and the atmosphere material entering the heat treatment equipment or the heat treatment gas-producing equipment together.

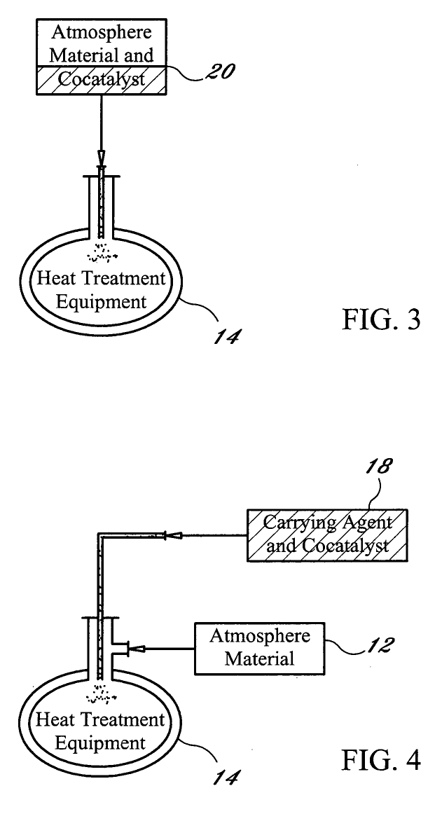

FIG. 3 is a sketch that illustrates the cocatalyst being dissolved and dispersed into the atmosphere material, and aerated into the heat treatment equipment together with atmosphere material.

FIG. 4 is a sketch that illustrates the cocatalyst being dissolved or dispersed into a carrying agent and aerated into the heat treatment equipment or heat treatment gas-producing equipment together with atmosphere material.

### EXAMPLE OF PRACTICE (METHOD AND COMPOUND)

In the atmosphere material (except Methanol) enumerated below, one kind or kinds of carbon compound can be used as the atmosphere material. The carbon compounds are Kerosene, Ethanol, N-butyl alcohol, Lsopropylalcohol, Xylenes, Toluene, Aniline, Acetone, Ethyl acetate, Methane, Ethane, Dimethylmethane, Butane, RX gas, Natural gas, and Coal gas.

A. Method and Contrast: (Hatching Part in Attached Drawing is New Content Increased in Original Drawing)

1. FIG. 1 illustrates a cocatalyst being gasified and atomized by the system and entering into the heat treatment equipment or heat treatment gas-producing equipment together with the atmosphere material.

2. FIG. 2 illustrates the cocatalyst and the atmosphere material entering the heat treatment equipment or heat treatment gas-producing equipment together. The cocatalyst and the atmosphere material are gasified together making use of the high temperature of heat treatment.

3. FIG. 3 illustrates the cocatalyst being dissolved, dispersed into the atmosphere material, and aerated into the heat treatment equipment together with the atmosphere material.

4. FIG. 4 illustrates selecting a kind of impregnant, which does not have a negative effect on the heat treatment atmosphere or heat treatment process. Such as impregnant can be selected from below: Methanol, Ethanol, Aniline, Toluene, Xylenes, Kerosene, Kerosene, Ethanol, N-butyl alcohol, Lsopropylalcohol, Acetone, Ethyl acetate, DimethylMethane, Butane, RX gas etc. The cocatalyst is dissolved and dispersed into the impregnant, and fed into the heat treatment equipment together with the atmosphere material. With existing technology, the catalyst should be activated in beat treatment gas-producing generator in for 30 days, and must be changed in about a year, during which change stopping the equipment is required. With the present invention, it should not be necessary to spend extra time to specially activate and change the cocatalyst. In original technology, the temperature of the gas-producing equipment should be controlled at above 1000°, so that gas-producing quality is stable and desirable. The atmosphere is maintained in the range CO₂≦0.5% and CH₄≦0.04%. Adopting the cocatalyst of the present invention, the lowest heat treatment temperature can be decreased to about 800°, while achieving the same gas-producing quality.
a) Natural gas and air are aerated into the heat treatment gas-producing equipment filled with Nickel catalyst at 1050° C., with the heat treatment equipment run successively for 35 days. CO₂ is 0.43% and CH₄ is 0.038% in the atmosphere through measure; Run successively heat treatment equipment for 40 days, CO₂ is 0.63%; CH₄ is 0.1% in the atmosphere. It is shown that the catalyst was poisoning severely. Taking out the catalyst, the catalyst had been surrounded almost completely.
b). Natural gas, air and a cocatalyst compound in present invention are aerated into the heat treatment gas-producing generator together without an accelerant at 950°, and the atmosphere is checked. After running successively for 35 days, the CO₂ of the atmosphere is 0.33%, CH₄ is 0.03%, after run successively in 45 days, the CO₂ of the atmosphere is 0.35%, CH₄ is 0.03%, after run successively in 60 days, the CO₂ of the atmosphere is 0.34%, CH₄ is 0.03%.
   6. In chemical heat treatment with existing technology, the highest carbon potential is less than 1.25% under a 920° process temperature, the highest carbon potential is less than 1.15% under a 880° process temperature, the highest carbon potential is less than 1.05% under a 850° process temperature, unless the carbon potential control using a oxygen probe fails as a effect of carbon soot and production would not continue. Using the method and cocatalyst of the present invention, the higher carbon potential can be increased by about 0.20% and carbon soot is not raised. Refer to Table 1.

7. Example: Natural gas and air are aerated into a 90 kw pit furnace or a 600 type of multi-furnace, using an oxygen probe to control atmosphere carbon potential, turning off the auto carbon-burning switch, testing oxygen probe failure time in different temperature carbon potential and with adding and not adding the cocatalyst compound of the present invention. The result is shown in Table 1.

TABLE 1

| | | | | Failure | | | |
|---|---|---|---|---|---|---|---|
| | | Carbon | | time of | Hardness depth in 4 hours | | |
| | Temp- | Poten- | Coca- | oxygen | strengthen carburizing (mm) | | |
| | erature | tial | talyst | probe | 20 | 20Cr | 20CrMnTi |
| 1 | 920° C. | 1.25% | N | <1 hour | 0.84 | 0.87 | 0.89 |
| | | | Y | >1 hour | 0.99 | 1.03 | 1.05 |
| | | 1.40% | N | <0.5 hour | 0.70 | 0.73 | 0.75 |
| | | | Y | >1 hour | 1.33 | 1.35 | 1.39 |
| 2 | 880° C. | 1.15% | N | <1 hour | 0.70 | 0.72 | 0.73 |
| | | | Y | >1 hour | 0.83 | 0.84 | 0.86 |
| | | 1.35% | N | <0.5 hour | 0.59 | 0.63 | 0.65 |
| | | | Y | >1 hour | 1.12 | 1.15 | 1.19 |
| 3 | 850° C. | 1.00% | N | <0.5 hour | 0.53 | 0.52 | 0.55 |
| | | | Y | >1 hour | 0.72 | 0.73 | 0.76 |
| | | 1.25% | N | <0.5 hour | 0.51 | 0.53 | 0.55 |
| | | | Y | >1 hour | 1.00 | 1.05 | 1.10 |
| 4 | 830° C. | 0.75% | N | <0.5 hour | 0.21 | 0.22 | 0.25 |
| | | | Y | >1 hour | 0.61 | 0.63 | 0.65 |
| | | 1.00% | N | <0.5 hour | 0.21 | 0.19 | 0.20 |
| | | | Y | >1 hour | 0.74 | 0.78 | 0.80 |

8. Under the 850° C. condition, Natural gas and air are aerated Natural gas into a 90 kw pit furnace or a 600-type multi-furnace without cocatalyst compound of the present invention. Atmosphere carbon potential is 1.00% with oxygen probe control. After 15 minutes, the oxygen probe seized up. The reason is that much more carbon covered the oxygen probe. Ten samples with the material being No. 20, 20Cr, 20CrMnTi (equivalent 8620 AISI), high 20 mm, diameter 90 mm, were placed respectively in said atmosphere to carry through a Carburizing experiment. The results we discovered through 4 hours of maintaining a temperature are: 1. The carbon thickness attached on the samples reached about 1 mm, 2. Table 1 shows the hardness depth result of three kinds of material.
9. Natural gas and air are aerated into a 90 kw pit furnace or a 600 type of multi-furnace respectively under conditions of 920° C., 880° C., 850° C., 830° C. without the cocatalyst compound of the present invention, using oxygen probe control atmosphere carbon potential. Ten samples with the material being No. 20, 20Cr, 20CrMnTi, diameter 90 mm, height 20 mm are placed respectively in the atmosphere to carry through a Carburizing experiment. Table 1 shows the Carburizing result with the three kinds of samples after 4 hours of heat preservation.
10. Natural gas, air and cocatalyst compound of present invention are aerated into a 90 kw of pit furnace or a 600 type of multi-furnace respectively under conditions of 920° C., 880° C., 850° C., 830° C., using oxygen probe control atmosphere carbon potential. Respectively put 10 samples with the material being 20, 20Cr, 20CrMnTi, diameter 90 mm, height 20 mm into the atmosphere to carry through a Carburizing experiment. The Carburizing result with the three kinds of samples are shown below after 4 hours of heat preservation. 1. There is obviously no carbon soot. 2. The results with three kinds of Carburizing of the samples are shown in Table 1.
11. Natural gas, air and cocatalyst compound of the present invention are aerated into a 90 kw of pit furnace or a 600 type of multi-furnace together respectively under conditions of 920° C., 880° C., 850° C., 830° C., using oxygen probe control atmosphere carbon potential. Respectively put 10 samples with the material being 20, 20Cr, 20CrMnTi, diameter 90 mm, height 20 mm into atmosphere that is fed a few ammonia gas to carry through a Carburizing experiment. The results with three kinds of Carburizing of the samples after 4 hours of heat preservation are shown below. 1. There is obviously no carbon soot. 2. The results with three kinds of Carburizing of the samples are shown in Table 1.
12. Aerate Natural gas and air Natural gas into a 105 kw pit furnace or 1000 type multi-furnace, carry through the experiment of protect atmosphere heat treatment for 2 hours under conditions of 920° C., 880° C., 850° C., 830° C. The atmosphere-protecting effect is much better after adding the cocatalyst compound of the present invention than before.
13. Aerate Natural gas and air into a 105 kw pit furnace or a 1000 type of multi-furnace respectively under conditions of 920° C., 880° C., 850° C., 830° C., control atmosphere carbon potential as 0.85% using a oxygen probe, put respectively 10 samples after carburizing that the material are 20, 20Cr, 20CrMnTi, diameter 90 mm, height 20 mm to do atmosphere-protecting heating quench experiment for 2 hours. The result is shown that the hardness is higher 1 to 2 degree after adding the cocatalyst compound of the present invention than before, and oxidation decarbonization does not take place.
B. The Explanation of Cocatalyst Application
1. The condition, method and result of experiment and contrast in the practice 11, 13, 16, 18, 20, 22, 25, 27 refer to the practice 5, 6, 7, 12.
2. The experiment condition, method, measure result and contrast in other practice refer to the practice 8, 9, 10, and 11.
3. There is an equivalent function in the compound halogen element in the practice below such as in that Trichlorobenzene, Chlorotoluene, chlorobenzene, Nitrochlorobenzene Carbon tetrachloride, Dichloroethane, Trichloroethane, Trichloroethylene, TTribromomethanemethane, Iodine, Iodinated Oil, Iodomethane, Freone, and Tetrafluoroethylene. They can be replaced each other in practice.
4. There is an equivalent function in the material such as metal element volatile organic compounds that have catalysis to the atmosphere material in the process of high temperature decomposition and oxidation. The materials below can be replaced with each other. The metal element volatile organic compounds can be Cobalt naphthenate, Manganese naphthenate, Nickel nitrate, Manganese nitrate, Ferrocene as well as Ferrocene ramification (such as Tert-butyl Ferrocene, Acetyl Ferrocene, Ferrocenyl ketone, Ferrocene formic acid, Butyl Ferrocene etc.)
5. There is an equivalent function in the material among the nitrogen volatile organic compounds listed in the practice below. The materials below can be replaced with each other. The nitrogen volatile organic compounds can be P-Amino-Azobenzene Hydrochloride, Nitrochlorobenzene, Nitrobenzene, Trinitrobenzene, Melamine, Tricyanic acid, Dicyandiamide, Guanidine nitrate, Aniline, Toluene diisocyanate, Cyclotrimethylenetrinitramine, Pyridine, Pyrazole, Pyraze, Formamide, Acetamide, Carbamide, Ammoniumnitrateetc.
6. The atmosphere carbon potential can be set up with Methanol, water and air in the practice below.
7. A cheaper inert gas such as nitrogen gas is added to decrease the costs of production, and ammonia gas is aerated to produce carbonitriding in the practice below.
C. Examples of the Cocatalyst

The Practice 1

It can accelerate carburizing and lower processing temperature in carburizing, carbonitriding and nitrocarburizing to add 2% weight of Chlorobenzene into Ethyl acetate as the atmosphere material and add Methanol, water and air to set up a carbon potential.

The Practice 2

It can accelerate carburizing and lower processing temperature in carburizing, carbonitriding and nitrocarburizing to add 1% weight of Trichloroethylene into Methanol as the atmosphere material and add kerosene to set up a carbon potential.

The Practice 3

It can accelerate carburizing and lower processing temperature in carburizing, carbonitriding and nitrocarburizing to add 4% weight of Chlorotoluene into Methanol as the atmosphere material.

The Practice 4

It can accelerate carburizing and lower processing temperature in carburizing, carbonitriding and nitrocarburizing to dissolve Dichloroethane into Methanol or other solvent, aerate it into the furnace together with atmosphere material together and control the weight of Dichloroethane to be 0.1% of atmosphere material fed into the furnace using one of Methane, Ethane, Dimethyl methane, Butane, RX gas and Natural gas, etc. as the atmosphere material.

The Practice 5

It can accelerate carbonizing and lower processing temperature in carburizing, carbonitriding and nitrocarburizing to diffuse Freone which takes 2% of weight in the atmosphere material fed into the furnace into the gas phase material and add Methanol, water and air to set up a carbon potential using one of Methane, Ethane, Dimethyl methane, Butane, RX gas, Natural gas and Coal gas, etc. as the atmosphere material.

The Practice 6

It can accelerate carbonizing and lower processing temperature in carburizing, carbonitriding and nitrocarburizing to add Cerium flouride (with the double function of rare earth and halogen) which takes 1.3% of weight in the atmosphere material fed into the furnace into Ethanol as the atmosphere material and add Methanol, water and air to set up a carbon potential.

The Practice 7

It can accelerate carburizing and lower processing temperature in carburizing, carbonitriding and nitrocarburizing to add Lanthanum flouride (with the double function of rare earth and halogen) which takes 1.9% of weight in the atmosphere material fed into the furnace into Methanol as the atmosphere material and add kerosene to set up a carbon potential.

The Practice 8

It can accelerate carburizing and lower processing temperature in carburizing, carbonitriding and nitrocarburizing to add respectively Cerium naphthenates which takes 2% of weight in the atmosphere material fed into the furnace and Trichloroethylene which takes 1% of the atmosphere material into Methanol and Benzene as the atmosphere material.

The Practice 9

It can accelerate carburizing and lower processing temperature in carburizing, carbonitriding and nitrocarburizing to dissolve Tribromomethane and Lanthanum nitrate into Methanol or other solvent, aerate them into the furnace together with the atmosphere material and control the weight of Tribromomethane to be 1% of the atmosphere material fed into the furnace and the weight of Lanthanum nitrate to to be 0.6% of the atmosphere material using one of Methane, Ethane, Dimethylmethane, Butane, RX gas and Natural gas, etc. as the atmosphere material.

The Practice 10

It can accelerate carburizing and lower processing temperature in carburizing, carbonitriding and nitrocarburizing to diffuse Iodine which takes 1.5% of weight in the atmosphere material fed into the furnace and Cerium naphthenates which takes 1.5% of weight in the atmosphere material into gas phase, aerate them into the furnace with atmosphere material together using one of Methane, Ethane, Dimethylmethane, Butane, RX gas and Natural gas, etc. as the atmosphere material

The Practice 11

Add Cobalt naphthenate that takes 0.015% of weight in the atmosphere material fed into the furnace into kerosene as the atmosphere material to make heat treatment atmosphere or process atmosphere heat treatment protection. It can decrease carbon soot and increase gas-producing quantity.

The Practice 12

It can accelerate carburizing and lower processing temperature in carburizing, carbonitriding and nitrocarburizing to add Manganese naphthenate which takes 0.02% weight of the atmosphere material fed into the furnace into Toluene as the atmosphere material and add Methanol, water and air to set up a carbon potential.

The Practice 13

Add Manganese nitrate that takes 0.01% of weight in the atmosphere material fed into the furnace into Methanol as the atmosphere material to make heat treatment atmosphere or process atmosphere heat treatment protection. It can decrease carbon soot and increase gas-producing quantity.

The Practice 14

It can accelerate carburizing and lower processing temperature in carburizing, carbonitriding and nitrocarburizing to add Nickel nitrate which takes 0.008% weight of the atmosphere material fed into the furnace into Methanol as atmosphere material and add Ethyl acetate to set up a carbon potential.

The Practice 15

It can accelerate carburizing and lower processing temperature in carburizing, carbonitriding and nitrocarburizing to add Ferrocenyl ketone which takes 0.0003% weight of the atmosphere material fed into the furnace into Methanol and Acetone as the atmosphere material.

The Practice 16

Using one of Methane, Ethane, Dimethylmethane, Butane, RX gas and Natural gas etc. as the atmosphere material, dissolve Cobalt naphthenate into Acetone or other solvent, aerate them into the furnace together with atmosphere material, control the quantity of Cobalt naphthenate to be 0.005% weight of the atmosphere material fed into the furnace, add Methanol, water or air to set up a carbon potential, make heat treatment atmosphere or process atmosphere heat treatment protection. It can decrease carbon soot and increase the atmosphere-producing quantity.

The Practice 17

It can accelerate carburizing and lower processing temperature in carburizing, carbonitriding and nitrocarburizing to dissolve Nickel nitrate into Methanol or other solvent, aerate it into the furnace together with the atmosphere material, control the quantity of Nickel nitrate to be 0.0008% weight of the atmosphere material fed into the furnace using one of Methane, Ethane, Dimethylmethanemethane, BButane, RX gas and Natural gas, etc. as the atmosphere material.

The Practice 18

It can decrease carbon soot, increase gas-producing quantity to diffuse Butyl Ferrocene which takes 0.008% of weight in the atmosphere material fed into the furnace into the gas phase, aerate it into the furnace together with atmosphere material, add Methanol, water or air to set up a carbon potential and make heat treatment atmosphere or process atmosphere heat treatment protection using one of Methane, Ethane, Dimethylmethanemethane, Butane, RX gas and Natural gas, etc. as the atmosphere material.

The Practice 19

It can accelerate carburizing and lower processing temperature in carburizing, carbonitriding and nitrocarburizing to diffuse acetyl ferrocene which takes 0.004% of weight in the atmosphere material fed into the furnace into the gas phase and aerate it into the furnace together with the atmosphere material using one of Methane, Ethane, Dimethylmethanemethane, Butane, RX gas and Natural gas etc. as the atmosphere material.

The Practice 20

It can decrease carbon soot, increase gas-producing quantity to add Ferrocenyl ketone which takes 0.03% weight of the atmosphere material fed into the furnace and Lanthanum chloride which takes 3% weight of the atmosphere material into Acetone as the atmosphere material, add Methanol, water or air to set up a carbon potential and make heat treatment atmosphere or process atmosphere heat treatment protection.

The Practice 21

Cerium chloride It can accelerate carburizing and lower processing temperature in carburizing, carbonitriding and nitrocarburizing to add Ferrocene formic acid which takes 0.0003% weight of the atmosphere material fed into the furnace and Cerium chloride which takes 2% weight of the atmosphere material into Xylenes as the atmosphere material and add Methanol, water or air to set up a carbon potential.

The Practice 22

It can decrease carbon soot, increase gas-producing quantity to add butyl ferrocene which takes 0.03% weight of the atmosphere material fed into the furnace and Lanthanum nitrate which takes 0.6% weight of the atmosphere material into Methanol as the atmosphere material to make heat treatment atmosphere or process atmosphere heat treatment protection.

The Practice 23

It can accelerate carburizing and lower processing temperature in carburizing, carbonitriding and nitrocarburizing to add Cobalt naphthenate which takes 0.002% weight of the atmosphere material fed into the furnace and Cerium nitrate which takes 3% weight of the atmosphere material into Methanol as the atmosphere material and add kerosene to set up a carbon potential.

The Practice 24

It can accelerate carburizing and lower processing temperature in carburizing, carbonitriding and nitrocarburizing to add Cobalt naphthenate which takes 0.08% weight of the atmosphere material fed into the furnace and Lanthanum nitrate which takes 0.1% weight of the atmosphere material into Methanol and Ethyl acetate as the atmosphere material.

The Practice 25

It can decrease carbon soot, increase gas-producing quantity to dissolve Manganese nitrate and Lanthanum naphthenates into Methanol or other solvent, aerate them into the furnace together with atmosphere material and control the weight of Manganese nitrate to be 0.01% of the atmosphere material fed into the furnace and the weight of Lanthanum naphthenates to be 0.5% of the atmosphere material and add Methanol, water or air to set up a carbon potential to make heat treatment atmosphere or process atmosphere heat treatment protection using one of Methane, Ehane, Dimethylmethanemethane, Butane, RX gas and Natural gas, etc. as the atmosphere material

The Practice 26

It can accelerate carburizing and lower processing temperature in carburizing, carbonitriding and nitrocarburizing to dissolve Lanthanum acetate and Cerium acetic acid into Methanol or other solvent, aerate them into the furnace together with the atmosphere material and control the weight of Lanthanum acetate to be 0.003% of the atmosphere material fed into the furnace and the weight of Cerium acetic acid to be 1% of the atmosphere material using one of Methane, Ethane, Dimethylmethanemethane, Butane, RX gas and Natural gas, etc. as the atmosphere material.

The Practice 27

It can decrease carbon soot, increase gas-producing quantity to diffuse Ferrocene which takes 0.0015% of weight in the atmosphere material fed into the furnace and Cerium naphthenates which takes 0.3% of weight in the atmosphere material into the gas phase, aerate it into the furnace together with the atmosphere material, add Methanol, water or air to set up a carbon potential to make heat treatment atmosphere or process atmosphere heat treatment protection using one of Methane, Ethane, Dimethylmethane, Butane, RX gas and Natural gas, etc. as the atmosphere material.

The Practice 28

It can accelerate carburizing and lower processing temperature in carburizing, carbonitriding and nitrocarburizing to diffuse acetyl ferrocene which takes 0.006% weight of the atmosphere material fed into the furnace and Cerium naphthenates which takes 1.5% weight of the atmosphere material into gas phase as the atmosphere material using one of Methane, Ethane, Dimethylmethane, Butane, RX gas, coal gas and Natural gas, etc. as the atmosphere material.

The Practice 29

It can accelerate carburizing and lower processing temperature in carburizing, carbonitriding and nitrocarburizing to add P-amino-azobenzene hydrochloride which takes 0.002% weight of the atmosphere material fed into the furnace into kerosene as the atmosphere material and add Methanol, water and air to set up a carbon potential.

The Practice 30

It can accelerate carburizing and lower processing temperature in carburizing, carbonitriding and nitrocarburizing to add Pyraze which takes 2% weight of the atmosphere material fed into the furnace into Methanol as the atmosphere material and add N-butyl alcohol to set up a carbon potential.

The Practice 31

It can accelerate carburizing and lower processing temperature in carburizing, carbonitriding and nitrocarburizing to add respectively Cyclotrimethylenetrinitramine which takes 1% weight of the atmosphere material fed into the furnace into Methanol and kerosene as the atmosphere material.

The Practice 32

It can accelerate carburizing and lower processing temperature in carburizing, carbonitriding and nitrocarburizing to dissolve Acetamide into Methanol or other solvent, aerate it into the furnace together with the atmosphere material, control the quantity of Nickel nitrate to be 6% weight of the atmosphere material fed into the furnace using one of Methane, Ethane, Dimethylmethanemethane, Butane, RX gas and Natural gas, etc. as the atmosphere material.

The Practice 33

It can accelerate carburizing and lower processing temperature in carburizing, carbonitriding and nitrocarburizing to add Formamide which takes 3% weight of the atmosphere material fed into the furnace into gas phase, aerate it into the furnace together with the atmosphere material and add Methanol, water and air to set up a carbon potential.

The Practice 34

It can accelerate carburizing and lower processing temperature in carburizing, carbonitriding and nitrocarburizing to add Cerium oxide which takes 2% weight of the atmosphere material fed into the furnace and pyrazole which takes 1% weight of the atmosphere material into Lsopropylalcohol as atmosphere material, and add Methanol, water and air to set up a carbon potential.

The Practice 35

It can accelerate carburizing and lower processing temperature in carburizing, carbonitriding and nitrocarburizing to add Lanthanum oxide which takes 1.2% weight of the atmosphere material fed into the furnace and melamine which takes 2% weight of the atmosphere material into Methanol as the atmosphere material, and add kerosene to set up a carbon potential.

The Practice 36

It can accelerate carburizing and lower processing temperature in carburizing, carbonitriding and nitrocarburizing to add respectively Cerium oxide which takes 1% weight of the atmosphere material fed into the furnace and Dicyandiamide which takes 1% weight of the atmosphere material into Methanol and N-butyl alcohol as the atmosphere material.

The Practice 37

It can accelerate carburizing and lower processing temperature in carburizing, carbonitriding and nitrocarburizing to dissolve Pyridine and Cerium naphthenates into Methanol or other solvent, aerate them into the furnace together with the atmosphere material, control the quantity of Pyridine to be 1% weight of the atmosphere material fed into the furnace and the quantity of Cerium naphthenates to be 0.6% weight of the atmosphere material using one of Methane, Ethane, Dimethylmethanemethane, Butane, RX gas and Natural gas, etc. as the atmosphere material.

The Practice 38

It can accelerate carburizing and lower processing temperature in carburizing, carbonitriding and nitrocarburizing to diffuse Cyclotrimethylenetrinitramine which takes 1% weight of the atmosphere material fed into the furnace and Cerium naphthenates which takes 1% weight of the atmosphere material into gas phase, aerate them into the furnace together with atmosphere material.

The Practice 39

It can accelerate carburizing and lower processing temperature in carburizing, carbonitriding and nitrocarburizing to add Cobalt naphthenate which takes 0.003% weight of the atmosphere material fed into the furnace and chlorobenzene which takes 2% weight of the atmosphere material into Ethyl acetate as the atmosphere material, and add Methanol, water and air to set up a carbon potential.

The Practice 40

It can accelerate carburizing and lower processing temperature in carburizing, carbonitriding and nitrocarburizing to add Nickel nitrate which takes 0.006% weight of the atmosphere material fed into the furnace and Trichloroethylene which takes 1% weight of the atmosphere material into Methanol as the atmosphere material, and add kerosene to set up a carbon potential.

The Practice 41

It can accelerate carburizing and lower processing temperature in carburizing, carbonitriding and nitrocarburizing to add respectively Ferrocene which takes 0.0009% weight of the atmosphere material fed into the furnace and Chlorotoluene which takes 2% weight of the atmosphere material into Methanol and kerosene as the atmosphere material.

The Practice 42

It can accelerate carburizing and lower processing temperature in carburizing, carbonitriding and nitrocarburizing to dissolve Manganese nitrate and Dichloroethane into Methanol or other solvent, aerate them into the furnace together with atmosphere material, control the quantity of Manganese nitrate to be 0.01% weight of the atmosphere material fed into the furnace and the quantity of Dichloroethane to be 1% weight of the atmosphere material using one of Methane, Ethane, Dimethylmethanemethane, Butane, RX gas and Natural gas, etc. as the atmosphere material.

The Practice 43

It can accelerate carburizing and lower processing temperature in carburizing, carbonitriding and nitrocarburizing to diffuse Ferrocene which takes 0.006% weight of the atmosphere material fed into the furnace and Freone which takes 2% weight of the atmosphere material into gas phase, aerate them into the furnace together with the atmosphere material, and add Methanol, water and air to set up a carbon potential.

The Practice 44

It can accelerate carburizing and lower processing temperature in carburizing, carbonitriding and nitrocarburizing to add Cobalt naphthenate takes 0.009% weight of the atmosphere material fed into the furnace, Cerium naphthenates which takes 1% weight of the atmosphere material and Nitrochlorobenzene which takes 2% weight of the atmosphere material into Ethanol as the atmosphere material, and add Methanol, water and air to set up a carbon potential.

The Practice 45

It can accelerate carburizing and lower processing temperature in carburizing, carbonitriding and nitrocarburizing to add Cobalt naphthenate takes 0.07% weight of the atmosphere material fed into the furnace, Lanthanum nitrate which takes 0.9% weight of the atmosphere material and Trichloroethane which takes 2% weight of the atmosphere material into Methanol as the atmosphere material, and add Methanol, water and air to set up a carbon potential.

The Practice 46

It can accelerate carburizing and lower processing temperature in carburizing, carbonitriding and nitrocarburizing to add Ferrocene takes 0.001% weight of the atmosphere material fed into the furnace, Cerium naphthenates which takes 2% weight of the atmosphere material and Trichloroethylene which takes 1% weight of the atmosphere material into Methanol as the atmosphere material.

The Practice 47

It can accelerate carburizing and lower processing temperature in carburizing, carbonitriding and nitrocarburizing to dissolve Manganese naphthenate, Tribromomethanemethane, and Lanthanum nitrate into Methanol or other solvent, aerate them into the furnace together with the atmosphere material, control the quantity of Manganese naphthenate to be 0.006% weight of the atmosphere material fed into the furnace, the quantity of Tribromomethanemethane to be 1% weight of the atmosphere material and the quantity of Lanthanum nitrate to be 0.6% weight of the atmosphere material using one of Methane, Ethane, Dimethylmethanemethane, Butane, RX gas and Natural gas, etc. as the atmosphere material.

The Practice 48

It can accelerate carburizing and lower processing temperature in carburizing, carbonitriding and nitrocarburizing to diffuse Ferrocene which takes 0.006% weight of the atmosphere material fed into the furnace, Iodine which takes 1.5% weight of the atmosphere material and Cerium naphthenates which takes 1% weight of the atmosphere material into the gas phase, aerate them into the furnace together with atmosphere material.

The Practice 49

It can accelerate carburizing and lower processing temperature in carburizing, carbonitriding and nitrocarburizing to add Iodinated oil takes 1% weight of the atmosphere material fed into the furnace and Guanidine nitrate which takes 2% weight of the atmosphere material into Methanol as the atmosphere material, add Methanol, water and air to set up a carbon potential.

The Practice 50

It can accelerate carburizing and lower processing temperature in carburizing, carbonitriding and nitrocarburizing to add Tribromomethanemethane takes 2% weight of the atmosphere material fed into the furnace and Nitrobenzene which takes 1% weight of the atmosphere material into Methanol as the atmosphere material, add Methanol, water and air to set up a carbon potential.

The Practice 51

It can accelerate carburizing and lower processing temperature in carburizing, carbonitriding and nitrocarburizing to add respectively Iodomethane takes 2% weight of the atmosphere material fed into the furnace and Tricyanic acid which takes 1% weight of the atmosphere material into Methanol and kerosene as the atmosphere material.

The Practice 52

It can accelerate carburizing and lower processing temperature in carburizing, carbonitriding and nitrocarburizing to dissolve Tetrafluoroethylene and Tricyanic acid into Methanol or other solvent, aerate them into the furnace with the atmosphere material together, control the quantity of tetrafluoroethylene to be 2% weight of the atmosphere material fed into the furnace and the quantity of tricyanic acid to be 1% weight of the atmosphere material using one of Methane, Ethane, Dimethylmethanemethane, Butane, RX gas and Natural gas, etc. as the atmosphere material.

The Practice 53

It can accelerate carburizing and lower processing temperature in carburizing, carbonitriding and nitrocarburizing to diffuse Carbon tetrachloride which takes 2% weight of the atmosphere material fed into the furnace and Toluene diisocyanate which takes 3% weight of the atmosphere material into gas phase, aerate them into the furnace together with the atmosphere material, and add Methanol, water and air to set up a carbon potential.

The Practice 54

It can accelerate carburizing and lower processing temperature in carburizing, carbonitriding and nitrocarburizing to add Lanthanum naphthenates which takes 2% weight of the atmosphere material fed into the furnace, Iodinated oil which takes 2% weight of the atmosphere material and Nitrochlorobenzene which takes 1% weight of the atmosphere material into gas phase, aerate them into the furnace together with the atmosphere material, and add Methanol, water and air to set up carbon potential.

The Practice 55

It can accelerate carburizing and lower processing temperature in carburizing, carbonitriding and nitrocarburizing to add Cerium chloride (with the double function of rare earth and halogen) which takes 1.6% of weight in the atmosphere material fed into the furnace and Nitrobenzene which takes 1% of weight in the atmosphere material into Methanol as atmosphere material and add kerosene to set up a carbon potential.

The Practice 56

It can accelerate carburizing and lower processing temperature in carburizing, carbonitriding and nitrocarburizing to add respectively Lanthanum naphthenates which takes 1.6% of weight in the atmosphere material fed into the furnace and Nitrochlorobenzene (with double function of rare earth and halogen) which takes 1% of weight in the atmosphere material into Methanol as the atmosphere material.

The Practice 57

It can accelerate carburizing and lower processing temperature in carburizing, carbonitriding and nitrocarburizing to dissolve Carbon tetrachloride, Pyridine and Cerium naphthenates into Methanol or other solvent, aerate them into the furnace together with atmosphere material, control the quantity of Carbon tetrachloride to be 1% weight of the atmosphere material fed into the furnace, the quantity of Pyridine to be 1% weight of the atmosphere material and the quantity of Cerium naphthenates to be 0.2% weight of the atmosphere material using one of Methane, Ethane, Dimethylmethanemethane, Butane, RX gas and Natural gas, etc. as the atmosphere material.

The Practice 58

It can accelerate carburizing and lower processing temperature in carburizing, carbonitriding and nitrocarburizing to diffuse Iodomethane which takes 1.1% weight of the atmosphere material fed into the furnace, Freone which takes 2% weight of the atmosphere material and Cerium naphthenates which takes 0.1% weight of the atmosphere material into gas phase, aerate them into the furnace together with atmosphere material, and add Methanol, water and air to set up a carbon potential.

The Practice 59

It can accelerate carburizing and lower processing temperature in carburizing, carbonitriding and nitrocarburizing to add Cobalt naphthenate which takes 0.002% weight of the atmosphere material fed into the furnace and P-amino-azobenzene hydrochloride which takes 2% weight of the atmosphere material into kerosene as the atmosphere material, add Methanol, water and air to set up a carbon potential.

The Practice 60

It can accelerate carburizing and lower processing temperature in carburizing, carbonitriding and nitrocarburizing to add Cobalt naphthenate which takes 0.02% weight of the atmosphere material fed into the furnace and Pyraze which takes 2% weight of the atmosphere material into Methanol as the atmosphere material, add N-butyl alcohol to set up a carbon potential.

The Practice 61

It can accelerate carburizing and lower processing temperature in carburizing, carbonitriding and nitrocarburizing to add respectively Ferrocene ramification which takes 0.0009% of weight in the atmosphere material fed into the furnace and Cyclotrimethylenetrinitramine which takes 1% of weight in the atmosphere material into Methanol and kerosene as the atmosphere material.

The Practice 62

It can accelerate carburizing and lower processing temperature in carburizing, carbonitriding and nitrocarburizing to dissolve Manganese nitrate and acetamide into Methanol or other solvent, aerate them into the furnace together with the atmosphere material, control the quantity of Manganese nitrate to be 0.006% weight of the atmosphere material fed into the furnace and the quantity of Acetamide to be 2% weight of the atmosphere material using one of Methane, Ethane, Dimethylmethanemethane, Butane, RX gas and Natural gas etc. as the atmosphere material.

The Practice 63

It can accelerate carburizing and lower processing temperature in carburizing, carbonitriding and nitrocarburizing to diffuse Acetyl ferrocene which takes 0.006% weight of the atmosphere material fed into the furnace and Formamide which takes 1% weight of the atmosphere material into gas phase, aerate them into the furnace together with the atmosphere material, and add Methanol, water and air to set up a carbon potential.

The Practice 64

It can accelerate carburizing and lower processing temperature in carburizing, carbonitriding and nitrocarburizing to add Cobalt naphthenate which takes 0.002% weight of the atmosphere material fed into the furnace, Cerium nitrate which takes 2% weight of the atmosphere material and Pyrazole which takes 1% weight of the atmosphere material into Lsopropylalcohol as the atmosphere material, add Methanol, water and air to set up a carbon potential.

The Practice 65

It can accelerate carburizing and lower processing temperature in carburizing, carbonitriding and nitrocarburizing to add Cobalt naphthenate which takes 0.02% weight of the atmosphere material fed into the furnace, Lanthanum nitrate which takes 1.2% weight of the atmosphere material and Melamine which takes 2% weight of the atmosphere material into Methanol as the atmosphere material, add kerosene to set up a carbon potential.

The Practice 66

It can accelerate carburizing and lower processing temperature in carburizing, carbonitriding and nitrocarburizing to add respectively Ferrocene formic acid which takes 0.0009% weight of the atmosphere material fed into the furnace, Cerium naphthenates which takes 1% weight of the atmosphere material and Dicyandiamide which takes 1% weight of the atmosphere material into Methanol and N-butyl alcohol as the atmosphere material.

The Practice 67

It can accelerate carburizing and lower processing temperature in carburizing, carbonitriding and nitrocarburizing to dissolve Manganese nitrate, Pyridine and Cerium naphthenates into Methanol or other solvent, aerate them into the furnace with the atmosphere material together, control the quantity of Manganese nitrate to be 0.02% weight of the atmosphere material fed into the furnace, the quantity of Pyridine to be 1% weight of the atmosphere material and the quantity of Cerium naphthenates to be 0.6% weight of the atmosphere material using one of Methane, Ethane, Dimethylmethanemethane, Butane, RX gas and Natural gas etc. as the atmosphere material.

The Practice 68

It can accelerate carburizing and lower processing temperature in carburizing, carbonitriding and nitrocarburizing to diffuse Tert-butyl ferrocene which takes 0.006% weight of the atmosphere material fed into the furnace, Guanidine nitrate which takes 1% weight of the atmosphere material and Cerium naphthenates which takes 1% weight of the atmosphere material into gas phase, aerate them into the furnace together with atmosphere material together.

The Practice 69

It can accelerate carburizing and lower processing temperature in carburizing, carbonitriding and nitrocarburizing to add Cobalt naphthenate which takes 0.003% weight of the atmosphere material fed into the furnace, Iodinated oil which takes 1% weight of the atmosphere material and Guanidine nitrate which takes 2% weight of the atmosphere material into acetone as the atmosphere material, add Methanol, water and air to set up a carbon potential.

The Practice 70

It can accelerate carburizing and lower processing temperature in carburizing, carbonitriding and nitrocarburizing to add Cobalt naphthenate which takes 0.002% weight of the atmosphere material fed into the furnace, Tribromomethanemethane which takes 2% weight of the atmosphere material and Nitrobenzene which takes 1% weight of the atmosphere material into Methanol as atmosphere material, add kerosene to set up a carbon potential.

The Practice 71

It can accelerate carburizing and lower processing temperature in carburizing, carbonitriding and nitrocarburizing to add respectively Ferrocene which takes 0.004% weight of the atmosphere material fed into the furnace, Iodomethane which takes 2% weight of the atmosphere material and tricyanic acid which takes 1% weight of the atmosphere material into Methanol and kerosene as atmosphere material.

The Practice 72

It can accelerate carburizing and lower processing temperature in carburizing, carbonitriding and nitrocarburizing to dissolve Manganese nitrate, tetrafluoroethylene and tricyanic acid into Methanol or other solvent, aerate them into the furnace with atmosphere material together, control the quantity of Manganese nitrate to be 0.006% weight of the atmosphere material fed into the furnace, the quantity of Tetrafluoroethylene to be 2% weight of the atmosphere material and the quantity of tricyanic acid to be 1% weight of the atmosphere material using one of Methane, Ethane, Dimethylmethanemethane, Butane, RX gas and Natural gas etc. as the atmosphere material.

The Practice 73

It can accelerate carburizing and lower processing temperature in carburizing, carbonitriding and nitrocarburizing to diffuse Manganese naphthenate which takes 0.003% weight of the atmosphere material fed into the furnace, toluene which takes 2% weight of the atmosphere material and Toluene diisocyanate which takes 3% weight of the atmosphere material into gas phase, aerate them into the furnace together with atmosphere material, and add Methanol, water and air to set up a carbon potential.

The Practice 74

It can accelerate carburizing and lower processing temperature in carburizing, carbonitriding and nitrocarburizing to add Cobalt naphthenate which takes 0.003% weight of the atmosphere material fed into the furnace, Lanthanum naphthenates which takes 2% weight of the atmosphere material and Trichlorobenzene which takes 0.004% weight of the atmosphere material into kerosene as atmosphere material, add Methanol, water and air to set up a carbon potential or add ammonia gas.

The Practice 75

It can accelerate carburizing and lower processing temperature in carburizing, carbonitriding and nitrocarburizing to add Cobalt naphthenate takes 0.02% weight of the atmosphere material fed into the furnace, Cerium chloride (instead of rare earth and halogen) which takes 1% weight of the atmosphere material and Nitrobenzene which takes 1% weight of the atmosphere material into Methanol as atmosphere material, add kerosene to set up a carbon potential.

The Practice 76

It can accelerate carburizing and lower processing temperature in carburizing, carbonitriding and nitrocarburizing to add Butyl ferrocene which takes 0.0009% weight of the atmosphere material fed into the furnace, Lanthanum naphthenates which takes 2% weight of the atmosphere material, Carbon tetrachloride which takes 2% weight of the atmosphere material and Trinitrobenzene which takes 1% weight of the atmosphere material into Methanol and Kerosene as atmosphere material, add Methanol water and air to set up a carbon potential.

The Practice 77

It can accelerate carburizing and lower processing temperature in carburizing, carbonitriding and nitrocarburizing to dissolve Manganese nitrate, Carbon tetrachloride, Pyridine and Cerium naphthenates into Methanol or other solvent, aerate them into the furnace together with atmosphere material, control the quantity of Manganese nitrate to be 0.01% weight of the atmosphere material fed into the furnace, the quantity of Carbon tetrachloride to be 1% weight of the atmosphere material, the quantity of Pyridine to be 1% weight of the atmosphere material, the quantity of Cerium naphthenates to be 0.2% weight of the atmosphere material using one of Methane, Ethane, Dimethylmethanemethane, Butane, RX gas and Natural gas etc. as the atmosphere material.

The Practice 78

It can accelerate carburizing and lower processing temperature in carburizing, carbonitriding and nitrocarburizing to diffuse Butyl Ferrocene which takes 0.006% weight of the atmosphere material fed into the furnace, Iodomethane which takes 1.1% weight of the atmosphere material, Freone which takes 2% weight of the atmosphere material and Cerium naphthenates which takes 0.1% weight of the atmosphere material into gas phase, aerate them into the furnace together with the atmosphere material.

The Practice 79

It can accelerate carburizing and lower processing temperature in carburizing, carbonitriding and nitrocarburizing to diffuse Butyl Ferrocene which takes 0.006% weight of the atmosphere material fed into the furnace, P-Amino-Azobenzene Hydrochloride which takes 1% weight of the atmosphere material, Freone which takes 2% weight of the atmosphere material and Cerium naphthenates which takes 0.1% weight of the atmosphere material into gas phase, aerate them into the furnace together with the atmosphere material.

The Practice 80

It can accelerate carburizing and lower processing temperature in carburizing, carbonitriding and nitrocarburizing to add the Chlorobenzene which takes 2% weight of the atmosphere material fed into the furnace into Ethyl acetate as the atmosphere material, adding Methanol, Water and Air to set up a carbon potential.

The Practice 81

It can accelerate carburizing and lower processing temperature in carburizing, carbonitriding and nitrocarburizing to add the Iodomethane which takes 2% weight of the atmosphere material fed into the furnace and Ammonium nitrate which takes 1% weight of the atmosphere material into Methanol and Kerosene as the atmosphere material.

The Practice 82

It can accelerate carburizing and lower processing temperature in carburizing, carbonitriding and nitrocarburizing to dissolve the Tetrafluoroethylene and Carbamide into Methanol or other solvent, aerate them into the furnace together with the atmosphere material, control the quantity of Tetrafluoroethylene to be 2% weight of the atmosphere material fed into the furnace and the quantity of Carbamide to be 1% weight of the atmosphere material using one of Methane, Ethane, Dimethylmethanemethane, Butane, RX gas as the atmosphere material.

1. A method for using a heat treatment atmosphere cocatalyst in an apparatus comprising heat treatment equipment or heat treatment-gas producing equipment having an atmosphere, the method comprising:
dissolving or dispersing the cocatalyst into a heat treatment atmosphere material, the cocatalyst existing in the form of a gas phase or a very fine dispersion in the heat treatment atmosphere material; and
diffusing the cocatalyst into the atmosphere of the heat treatment equipment or heat treatment gas-producing equipment.

2. The method of claim 1 wherein the cocatalyst is diffused directly into the heat treatment atmosphere material in the form of a gas phase or a very fine dispersion, or the cocatalyst is dissolved or dispersed into a carrying agent to produce an admixture, and said admixture is fed into heat treatment equipment or heat treatment gas-producing equipment.

3. (canceled)

4. (canceled)

5. A cocatalyst for a heat treatment atmosphere material, the cocatalyst comprising one or more components selected from the group consisting of:
a halogen element compound which takes 0.1-4% by weight in the heat treatment atmosphere material;
a metal element compound which takes 0.0003-0.03% by weight in the heat treatment atmosphere material; and
a nitrogen compound which takes 1-10% by weight in the heat treatment atmosphere material;
wherein said metal element compound is one or more than one compound selected from the group consisting of cobalt naphthenate, manganese naphthenate, nickel nitrate, manganese nitrate, ferrocene, and ferrocene ramification;
wherein said halogen element compound is one or more than one compound selected from the group consisting of chlorobenzene, trichlorobenzene, chlorotoluene, nitrochlorobenzene, trichloroethylene, ribromomethane, iodine, iodinated oil, iodomethane, freone, and tetrafluoroethylene;
wherein said said nitrogen compound is one or more than one compound selected from the group consisting of p-amino-azobenzene hydrochloride, nitrobenzene, toluenediisocyanate, nitrochlorobenzene, trinitrobenzene, melamine, tricyanic acid, dicyandiamide, guanidine nitrate, cyclotrimethylenetrinitramine, pyridine, pyrazol, and pyraze; and
wherein said cocatalyst is capable of being maintained in the form of a gas phase or a very fine dispersion in the heat treatment atmosphere material.

6. The heat treatment atmosphere cocatalyst according to claim 5, further comprising: a rare earth compound comprising lanthanum or cerium which takes 0.1-3% by weight in the heat treatment atmosphere material;
wherein said rare earth compound is selected from the group consisting of cerium naphthenate, lanthanum naphthenate, cerium nitrate, lanthanum nitrate, lanthanum chloride, cerium chloride, lanthanum fluoride, and cerium fluoride.

7. A method for atmosphere heat treatment of a metal material, said method comprising:
heat treating the metal material in a heat treatment atmosphere with a cocatalyst or an active heat treatment atmosphere produced by said cocatalyst
wherein said cocatalyst is diffused into said heat treatment atmosphere in the form of a gas phase or a very fine dispersion, and releases a substance that activates the heat treatment atmosphere.

8. (canceled)

9. (canceled)

10. (canceled)

11. (canceled)

12. (canceled)

13. The cocatalyst of claim 5 wherein the cocatalyst comprises at least one component selected from the group consisting of:
a halogen element compound which takes 0.1-1% by weight in the heat treatment atmosphere material;
a metal element compound which takes 0.0003-0.015% by weight in the heat treatment atmosphere material; and
a nitrogen compound which takes 1-2% by weight in the heat treatment atmosphere material.

14. The cocatalyst of claim 5 wherein:
said metal element compound is at least one compound selected from the group consisting of: ferrocene, and ferrocene ramification;
said halogen element compound is at least one compound selected from the group consisting of: chlorobenzene, trichlorobenzene, chlorotoluene, and nitrochlorobenzene; and
said nitrogen compound is at least one compound selected from the group consisting of: p-amino-azobenzene hydrochloride, nitrobenzene, toluenediisocyanate, nitrochlorobenzene, trinitrobenzene, guanidine nitrate, and cyclotrimethylenetrinitramine.

15. A composition of matter for catalyzing a reaction in a heat treatment atmosphere, said composition of matter comprising at least one component selected from the group consisting of:
a halogen element compound which takes 0.1-4% by weight in the heat treatment atmosphere;
a metal element compound which takes 0.0003-0.03% by weight in the heat treatment atmosphere; and
a nitrogen compound which takes 1-10% by weight in the heat treatment atmosphere;
wherein said metal element compound is at least one compound selected from the group consisting of: cobalt naphthenate, manganese naphthenate, nickel nitrate, manganese nitrate, ferrocene, and ferrocene ramification;
wherein said halogen element compound is at least one compound selected from the group consisting of: chlorobenzene, trichlorobenzene, chlorotoluene, nitrochlorobenzene, trichloroethylene, ribromomethane, iodine, iodinated oil, iodomethane, freone, and tetrafluoroethylene;
wherein said said nitrogen compound is at least one compound selected from the group consisting of: p-amino-azobenzene hydrochloride, nitrobenzene, toluenediisocyanate, nitrochlorobenzene, trinitrobenzene, melamine, tricyanic acid, dicyandiamide, guanidine nitrate, cyclotrimethylenetrinitramine, pyridine, pyrazol, and pyraze; and
wherein said cocatalyst is capable of existing in the form of a gas phase or a very fine dispersion in the heat treatment atmosphere.

16. A method for making a heat treatment atmosphere, said method comprising:
combining the composition of matter of claim 15 with a heat treatment atmosphere material.

17. A method for heating treating a metal, said method comprising:
exposing the metal to the composition of matter of claim 15 in an apparatus comprising heat treatment equipment under conditions that are operative to achieve heat treatment.

18. A method for making a heat treatment atmosphere, said method comprising:
combining the composition of matter of claim 15 with a carrying agent; and
dispersing the carrying agent in a heat treatment atmosphere material.

19. A method for heating treating a metal, said method comprising:
exposing the metal to the cocatalyst of claim 5 in an apparatus comprising heat treatment equipment under conditions that are operative to achieve heat treatment.

20. A method for heating treating a metal, said method comprising:
exposing the metal to the heat treatment cocatalyst of claim 6 in an apparatus comprising heat treatment equipment under conditions that are operative to achieve heat treatment.
